(19) United States
(12) Patent Application Publication
(10) Pub. No.: US 2022/0309603 A1
(43) Pub. Date: Sep. 29, 2022

(54) HOME DELIVERY DEVICE

(71) Applicant: HONDA MOTOR CO., LTD., Tokyo (JP)

(72) Inventors: Isao Uematsu, Tokyo (JP); Kuniaki Matsushima, Tokyo (JP); Yurie Kondo, Tokyo (JP); Nozomi Noda, Tokyo (JP); Kensaku Yamamoto, Tokyo (JP)

(73) Assignee: HONDA MOTOR CO., LTD., Tokyo (JP)

(21) Appl. No.: 17/702,192

(22) Filed: Mar. 23, 2022

(30) Foreign Application Priority Data
Mar. 26, 2021 (JP) 2021-053608

(51) Int. Cl. G06Q 50/28; G05D 1/02; H04W 4/35; G06V 20/56; G06V 40/10

(52) U.S. Cl. CPC G06Q 50/28; G05D 1/0231; H04W 4/35; G06V 20/56; G06V 40/10

(57) ABSTRACT

A home delivery device that autonomously delivers a package to a dwelling in an apartment building includes a detection unit configured to detect a target around the home delivery device, and a delivery determination unit configured to determine whether or not to permit the delivery of the package. When the home delivery device arrives at the dwelling as a delivery destination and the detection unit detects that a person comes out of the dwelling, the delivery determination unit determines that the delivery of the package to the person is permitted.

### CROSS-REFERENCE TO RELATED APPLICATION(S)

This application claims priority to and the benefit of Japanese Patent Application No. 2021-053608 filed on Mar. 26, 2021, the entire disclosure of which is incorporated herein by reference.

### BACKGROUND OF THE INVENTION

### Field of the Invention

The present invention relates to an autonomous home delivery device.

### Description of the Related Art

A robot that autonomously moves in a building and performs various services has been proposed (for example, Japanese Patent Laid-Open No. 2017-220123).

As one of such methods of using the robot, a package delivery service in an apartment building can be considered. When the package is delivered to the recipient, it is desirable to authenticate whether or not the recipient is a valid recipient. However, when authentication is uniformly performed to determine whether or not the recipient is a valid recipient at the time of delivery, the smooth operation of the service may be impaired.

### SUMMARY OF THE INVENTION

An object of the present invention is to provide a home delivery device capable of smoothly operating a home delivery service for a package.

According to an aspect of the present invention, there is provided a home delivery device that autonomously delivers a package to a dwelling in an apartment building, the home delivery device comprising: a detection unit configured to detect a target around the home delivery device; and a delivery determination unit configured to determine whether or not to permit the delivery of the package, wherein when the home delivery device arrives at the dwelling as a delivery destination and the detection unit detects that a person comes out of the dwelling, the delivery determination unit determines that the delivery of the package to the person is permitted.

Further features of the present invention will become apparent from the following description of exemplary embodiments (with reference to the attached drawings).

### BRIEF DESCRIPTION OF THE DRAWINGS

FIG. 1A is a side view of a home delivery device according to an embodiment of the present invention;

FIG. 1B is an explanatory diagram of an internal structure of the home delivery device illustrated in FIG. 1A;

FIG. 2 is a block diagram of a control system of the home delivery device illustrated in FIG. 1A;

FIG. 3 is an explanatory diagram of an example of a home delivery service in an apartment building;

FIG. 4 is a flowchart illustrating an example of a process to be performed by a control unit;

FIGS. 5A and 5B are diagrams illustrating examples of captured images;

FIG. 6A is a diagram illustrating a display example at the time of delivery; and

FIG. 6B is a diagram illustrating an example of a delivery request.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

<Outline of Home Delivery Device>

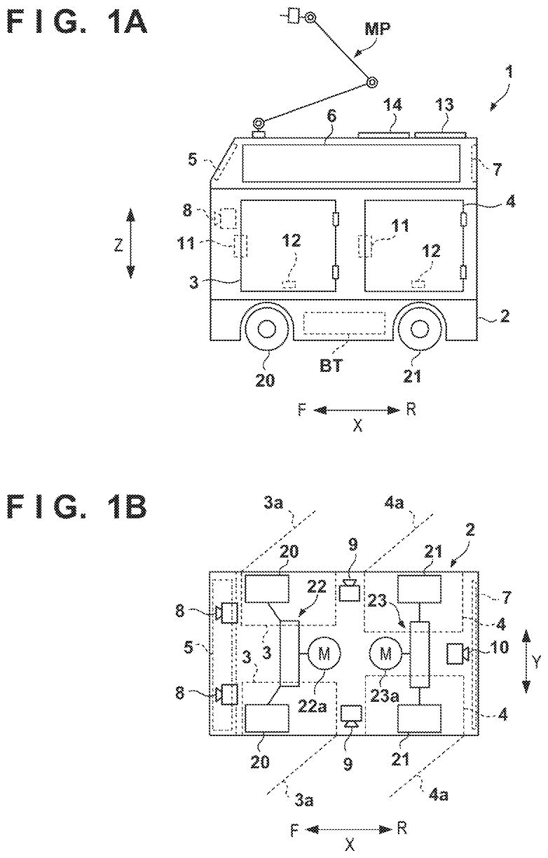

FIG. 1A is a side view of a home delivery device 1 according to an embodiment of the present invention, and FIG. 1B is an explanatory diagram of an internal structure of the home delivery device 1. In the drawings, an arrow X indicates the front-and-rear direction of the home delivery device 1, F indicates the front side, and R indicates the rear side. Arrows Y and Z indicate a width direction (left-right direction) of the home delivery device 1 and a vertical direction, respectively.

The home delivery device 1 is an electric autonomous vehicle that includes a traveling unit 2 and a battery BT as a main power supply. The battery BT is, for example, a secondary battery such as a lithium ion battery, and the home delivery device 1 autonomously travels by the traveling unit 2 using electric power supplied from the battery BT. The traveling unit 2 is a four-wheeled vehicle including a pair of left and right front wheels 20 and a pair of left and right rear wheels 21. The traveling unit 2 may be in another form such as a three-wheel vehicle form.

The traveling unit 2 includes a steering mechanism 22. The steering mechanism 22 uses a motor 22a as a drive source to change the steering angle of the pair of front wheels 20. By changing the steering angle of the pair of front wheels 20, the traveling direction of the home delivery device 1 can be changed. The traveling unit 2 also includes a drive mechanism 23. The drive mechanism 23 uses a motor 23a as a drive source to rotate the pair of rear wheels 21. By rotating the pair of rear wheels 21, the home delivery device 1 can be moved forward or backward.

The home delivery device 1 includes detection units 8 to 10 that detect a target around the home delivery device 1. The detection units 8 to 10 are a group of external sensors that monitor the surroundings of the home delivery device 1. In the present embodiment, each of the detection units 8 to 10 is an imaging device that captures an image of the surroundings of the home delivery device 1 and includes, for example, an optical system such as a lens and an image sensor. However, instead of or in addition to the imaging device, a radar or a light detection and ranging (LIDAR) can also be used.

The two detection units 8 are disposed on the front side of the home delivery device 1 while being separate from each other in the Y direction, and mainly detect a target in front of the home delivery device 1. The detection units 9 are disposed on the left and right sides of the home delivery device 1 and mainly detect a target on the left and right sides of the home delivery device 1. The detection unit 10 is disposed on the rear side of the home delivery device 1 and mainly detects a target behind the home delivery device 1.

The home delivery device 1 includes a plurality of storage units 3 and 4 (four storage units in total in the present embodiment), each of which stores a package. Each of the storage units 3 and 4 has a box-shaped storage space, and the storage units 4 have a larger volume than the storage units 3. Therefore, it is suitable to store a large package in each storage unit 4 and store a small package in each storage unit 3.

The two storage units 3 are disposed on the front side of the home delivery device 1. One of the two storage units 3 is provided with a door 3a in the left side surface of the home delivery device 1, and a package can be put in and taken out of the storage unit 3 from the left side of the home delivery device 1 by opening the door 3a. The other of the two storage units 3 is provided with a door 3a in the right side surface of the home delivery device 1, and a package can be put in and taken out of the storage unit 3 from the right side of the home delivery device 1 by opening the door 3a. FIG. 1A illustrates a state in which the doors 3a are closed, and FIG. 1B illustrates a state in which the doors 3a are opened.

The two storage units 4 are disposed on the rear side of the home delivery device 1. One of the two storage units 4 is provided with a door 4a in the left side surface of the home delivery device 1, and a package can be put in and taken out of the storage unit 4 from the left side of the home delivery device 1 by opening the door 4a. The other of the two storage units 4 is provided with a door 4a in the right side surface of the home delivery device 1, and a package can be put in and taken out of the storage unit 4 from the right side of the home delivery device 1 by opening the door 4a. FIG. 1A illustrates a state in which the doors 4a are closed, and FIG. 1B illustrates a state in which the doors 4a are opened.

Each of the storage units 3 and 4 has a switching unit 11 and a storage sensor 12 individually. The switching units 11 according to the present embodiment are locking and unlocking mechanisms of the doors 3a and 4a. Each of the switching units 11 uses an actuator such as a solenoid or a motor as a drive source.

When the switching units 11 lock the doors 3a and 4a, the storage spaces of the storage units 3 and 4 are closed by the doors 3a and 4a, and the storage units 3 and 4 are in a closed state where it is difficult for a package to be put in and taken out of the storage units 3 and 4. In addition, when the switching units 11 unlock the doors 3a and 4a, the doors 3a and 4a can be opened, and the storage units 3 and 4 are in an open state in which a package can be put in and taken out of the storage units 3 and 4.

Each of the storage sensors 12 is, for example, an optical sensor or a pressure sensor. The storage sensors 12 detect whether or not a package is stored in the storage spaces of the storage units 3 and 4.

Display units 5 to 7 are disposed on an upper peripheral surface of the home delivery device 1. The display units 5 to 7 are, for example, liquid crystal display panels, and display information to a delivery person, a recipient, and other people around them. The display unit 5 is disposed at a front portion of the home delivery device 1. The display units 6 are disposed at a left side portion and a right side portion of the home delivery device 1. The display unit 7 is disposed at a rear portion of the home delivery device 1.

A manipulator MP is disposed on the top part of the home delivery device 1 so as to be storable. The manipulator MP is provided to operate buttons such as an entrance button at an entrance of an apartment building, a destination floor button of an elevator, and a button of an interphone at an entrance of a dwelling.

The top part of the home delivery device 1 is also provided with an operation panel 13 and a reader 14. The operation panel 13 is, for example, a touch panel, and accepts various request operations of the delivery person and the recipient. Furthermore, the reader 14 is, for example, a device that optically reads a two-dimensional code, and reads a code presented from the delivery person or the recipient and performs processing corresponding to the read code. The delivery person can input information regarding a package from the operation panel 13 or the reader 14. The recipient can input information regarding a request to deliver a package from the operation panel 13 or the reader 14.

<Control System>

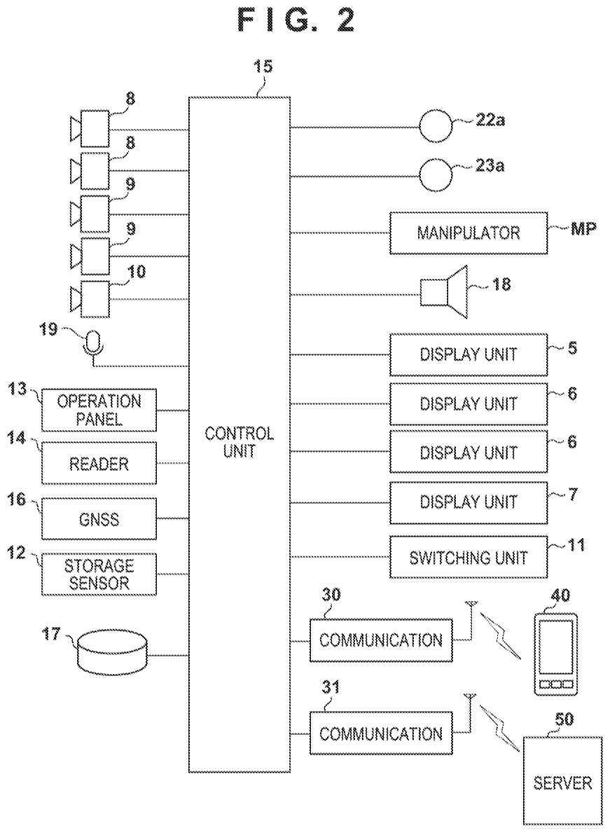

FIG. 2 is a block diagram of a control system of the home delivery device 1. The home delivery device 1 includes a control unit (ECU) 15. The control unit 15 includes a processor represented by a CPU, a storage device such as a semiconductor memory, an interface with an external device, and the like. In the storage device, a program to be executed by the processor, data to be used by the processor to execute processing, and the like are stored. A plurality of sets of the processors, the storage devices, and the interfaces may be provided for each function of the home delivery device 1 and configured to be able to communicate with each other.

The control unit 15 acquires detection results of the detection units 8 to 10, input information of the operation panel 13 and the reader 14, and detection results of the storage sensors 12, and executes processing corresponding to the acquired detection results and the acquired information. A voice input device 19 collects the voice of the delivery person, the recipient, or another person. The control unit 15 can recognize the input voice and execute processing corresponding to the recognized input voice. A global navigation satellite system (GNSS) sensor 16 receives a GNSS signal to detect the current position of the home delivery device 1. A storage device 17 is a mass storage device that stores information on the apartment building as a delivery destination, information on a dwelling as a delivery destination, information on a package, and the like.

The control unit 15 controls the motors 22a and 23a (control of the traveling of the traveling unit 2), controls the operation of the manipulator MP, controls the displaying of the display units 5 to 7, and controls the locking and unlocking of the switching units 11. The control unit 15 also causes a voice output device 18 to notify the delivery person, the recipient, or another person by voice and output information. A communication device 30 can perform near-field wireless communication with a mobile terminal of the delivery person, a mobile terminal of the recipient, and a communication terminal in the apartment building. A communication device 31 can wirelessly communicate with the home delivery device 1 and the server 50 that manages all home delivery services via a communication network such as the Internet. The home delivery device 1 is managed by, for example, a management association of the apartment building or a delivery agent.

<Form of Delivery in Apartment Building>

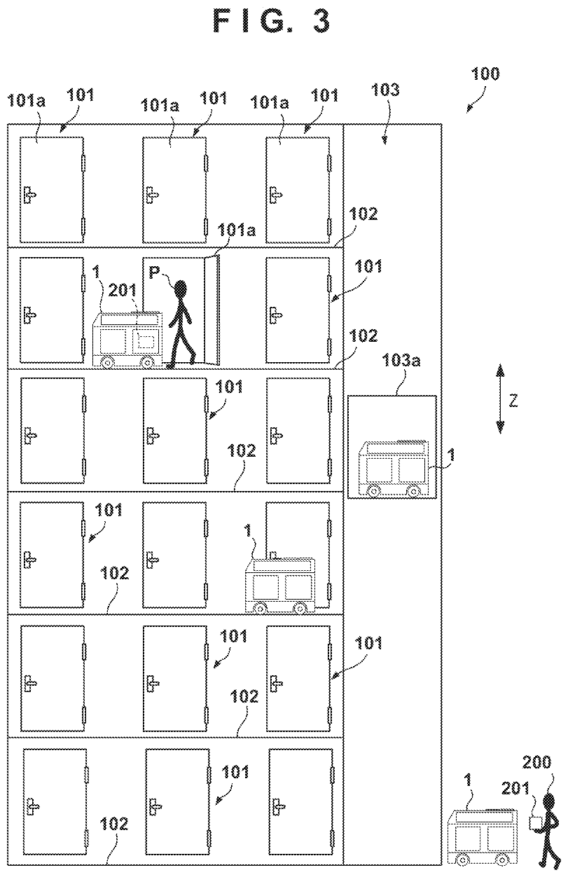

FIG. 3 is an explanatory diagram of an example of a home delivery service by the home delivery device 1 in an apartment building 100. The apartment building 100 has a plurality of floors and a person can move between the floors using an elevator 103. In an apartment building with a large number of dwellings, such as a tower condominium building, the home delivery service by the home delivery device 1 is advantageous, and it is possible to deliver a package within a shorter time while reducing the burden on the delivery person.

A delivery person 200 stores a package 201 in the home delivery device 1 on the ground, and inputs information such as a delivery destination to the home delivery device 1. The information can be input by any of wireless communication between a mobile terminal of the delivery person 200 and the communication device 30, an operation performed by the delivery person 200 on the operation panel 13, or the presentation of a code to the reader 14. In the present embodiment, the example of loading the package on the home delivery device 1 has been described, but the package can be loaded at another place and the home delivery device 1 can be transported.

The home delivery device 1 stores information necessary for autonomously moving in the apartment building 100 in the storage device 17 in advance. This information includes, for example, a floor map of the apartment building 100 provided from the management association of the apartment building 100, or information obtained by the home delivery device 1 from past delivery records or preliminary learning. Using such information and the detection results of the detection units 8 to 10 and the GNSS sensor 16, the home delivery device 1 autonomously moves to a dwelling 101 as a delivery destination.

The home delivery device 1 uses the elevator 103 to move between floors. The home delivery device 1 boards an elevator car 103a, and a destination floor is designated by an operation using the manipulator MP or communication between a communication terminal on the elevator 103 side and the communication device 30. When the home delivery device 1 arrives at the destination floor, the traveling unit 2 travels along a common corridor 102 toward the dwelling 101 as the delivery destination. At the dwelling 101 as the delivery destination, the package 201 is delivered to a resident P as a recipient. In a case where packages for a plurality of delivery destinations are stored, the home delivery device 1 delivers the packages by sequentially moving to the delivery destinations.

<Delivery Conditions>

A package must be reliably delivered to a recipient. However, when the authentication of the person himself/herself is always required, the smooth operation of the service may be impaired. For example, in a case where a receipt code is transmitted from the server 50 to a mobile terminal 40 of the recipient in advance, and the delivery of the package is permitted on condition that the recipient inputs the receipt code to the home delivery device 1, the package can be delivered to the person himself/herself more reliably.

However, in a case where the recipient does not carry the mobile terminal 40 or erases the receipt code, the recipient cannot receive the package even though the recipient is the person himself/herself. Also, a person living in the same dwelling as the recipient cannot receive the package instead.

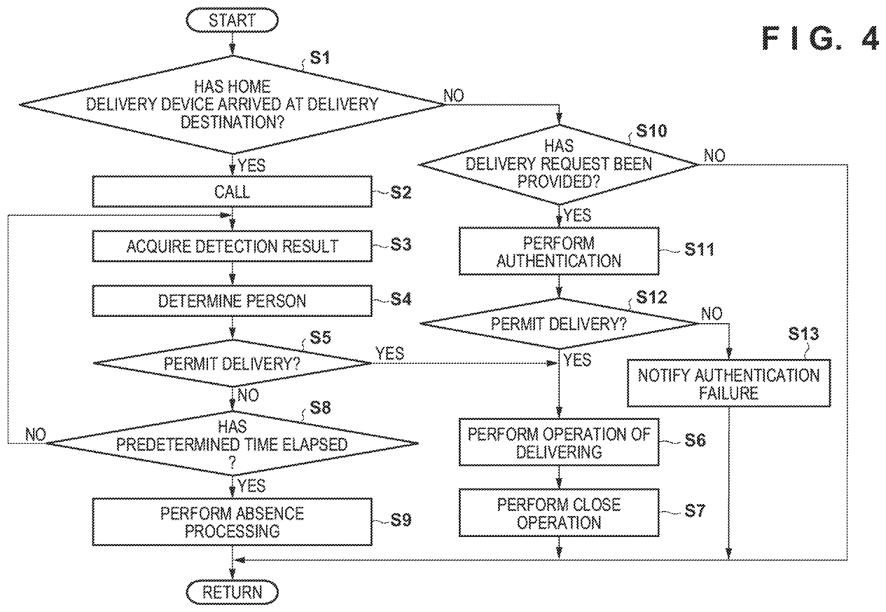

Therefore, in the present embodiment, in a case where it has been confirmed that a person has come from the dwelling after the home delivery device 1 has arrived at the dwelling as a delivery destination, the home delivery device 1 treats the person as the recipient or a person acting on behalf of the recipient and living in the same dwelling as the recipient, the authentication of the person is omitted, and the delivery of the package is permitted. On the other hand, when the delivery of the package is requested outside the dwelling, the authentication of the person himself/herself is performed. FIG. 4 is a flowchart of an exemplary process to be performed by the processor of the control unit 15 for the delivery of a package.

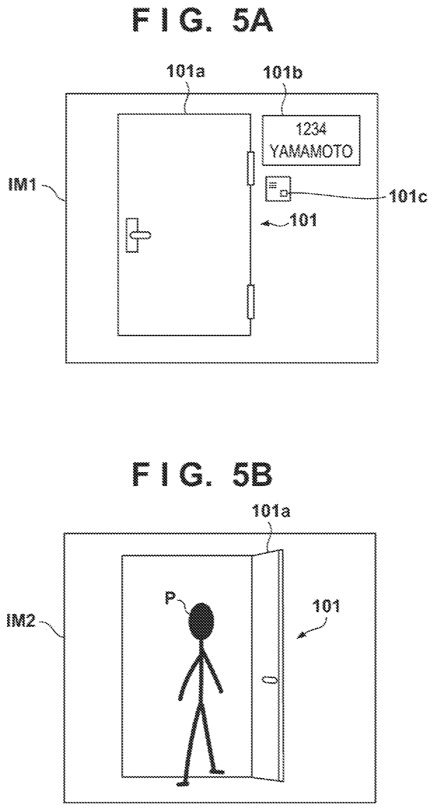

In S1, it is determined whether or not the home delivery device 1 has arrived at the dwelling 101 as the delivery destination. When it is determined that the home delivery device 1 has arrived at the dwelling 101, the process proceeds to S2. When it is determined that the home delivery device 1 has not arrived at the dwelling 101, the process proceeds to S10. In this determination, when the identification display of the dwelling 101 attached to the dwelling 101 as the delivery destination is detected, it can be determined that the home delivery device 1 has arrived at the dwelling 101. In the present embodiment, this determination can be made based on an image captured by each of the detection units 8 to 10. FIG. 5A illustrates a captured image IM1 as an example.

In the illustrated example, a display plate 101b of a room number is shown in the captured image IM1 as the identification display of the dwelling 101. The control unit 15 performs character recognition on the image of the display plate 101b, and determines that the home delivery device 1 has arrived at the dwelling 101 as the delivery destination when the recognition result matches the room number as the delivery destination by collating.

Conditions for the determination of the arrival may include other conditions such as the detection of an entrance door 101a in addition to the detection of the identification display of the dwelling 101. In addition, whether or not the home delivery device 1 has arrived at the dwelling 101 as the delivery destination may be determined by detecting the identification display of the dwelling 101 and, for example, in a case where a communication terminal is individually provided in the dwelling 101, by checking by wireless communication between the communication terminal and the communication device 30.

In S2, call processing to call the recipient of the dwelling 101 as the delivery destination is performed. As a call method, there is a method of operating an interphone 101c by the manipulator MP and notifying a message (package delivery) from the voice output device 18. In addition, as another calling method, there is a method of calling by wireless communication between the communication terminal and the communication device 30 in a case where the communication terminal is individually provided in the dwelling 101. As still another calling method, there is a method of calling by wireless communication between the mobile terminal 40 of the recipient and the communication device 30.

In S3, a detection result of each of the detection units 8 to 10 is acquired. In S4, it is determined whether or not a person has come out of the dwelling 101 on the basis of the captured image of each of the detection units 8 to 10 acquired in S3. FIG. 5B illustrates a captured image IM2 as an example. In the illustrated example, the entrance door 101a is opened, and a person P comes out of the dwelling 101. In this case, in S4, it is determined that the person has come out. On the other hand, when the presence of a person or the opening of the entrance door 101a cannot be recognized as in the captured image IM1 of FIG. 5A, it is determined that no person has come out in S4.

In S5, it is determined whether or not to permit the delivery of the package. In a case where it is determined that a person has come out in S4, authentication that the person is a valid recipient is omitted by treating the person as the recipient or a person acting on behalf of the recipient and living in the same dwelling as the recipient, the delivery of the package is permitted, and the process proceeds to S6. When it is determined that no person has come out in S4, the process proceeds to S8.

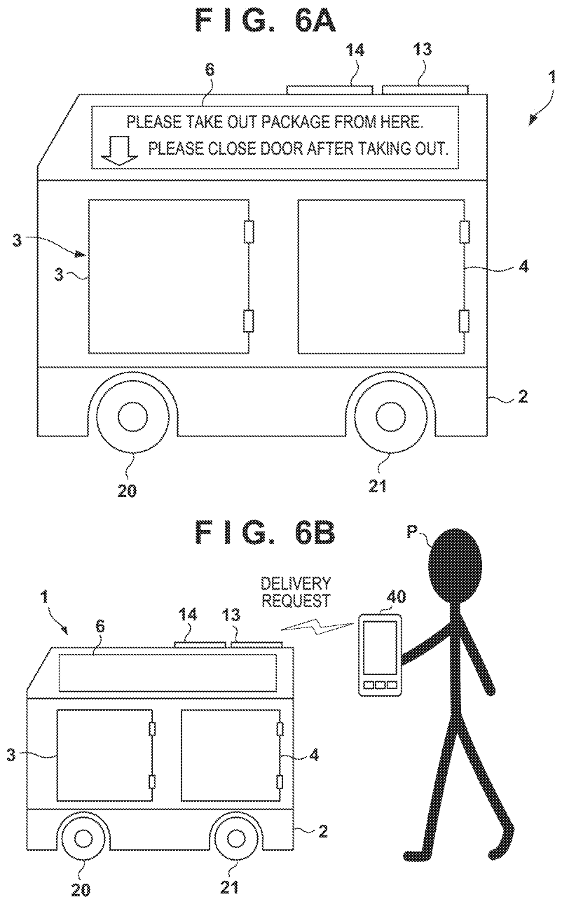

In S6, an operation of delivering the package is performed. In this case, the switching unit 11 corresponding to the storage unit 3 or 4 in which the package to be delivered is stored is driven to open the storage unit in which the package to be delivered is stored. At that time, the storage unit in which the package is stored is identified and the recipient is requested to take out the package. As a request method, in an example of FIG. 6A, an arrow indicating the storage unit and a message requesting the removal of the package are displayed on the display unit 6. In response to this request, the recipient opens the door 3a of the left storage unit 3 to take out the stored package.

When the package is taken out, the switching unit 11 is driven to bring the storage unit into a closed state in S7. Whether or not the package has been taken out can be determined from a detection result of the storage sensor 12. Thus, the package delivery is completed. As the checking of the delivery of the package, a signature may be requested to the operation panel 13. Alternatively, the captured image illustrated in FIG. 5B may be stored in the storage device 17 as an image for checking the delivery. The information for checking the delivery may be transmitted to the server 50 and stored in the server 50 as delivery completion information.

In S8, it is determined whether or not a predetermined time (for example, one minute) has elapsed from the call of S2. When the predetermined time has elapsed, the process proceeds to S9. When the predetermined time has not elapsed, the process returns to S3 to repeat the same process. In S9, absence processing is performed. In this case, the communication device 31 transmits information indicating that the delivery cannot be made from the control unit 15 to the server 50, and the server 50 stores the information as undelivered information. In such a case, the server 50 may notify the mobile terminal 40 of the recipient that the delivery cannot be made due to absence.

The processing of S10 to S13 relates to processing of delivering the package to the recipient at a location different from the dwelling 101 as the delivery destination. When the recipient finds the home delivery device 1 in the middle of delivery while moving in the apartment building 100, the recipient can receive the package on the spot without returning to the dwelling 101. The recipient can input information regarding a request to deliver the package from the operation panel 13 or the reader 14. Alternatively, the recipient can input the information regarding the delivery request by wireless communication between the mobile terminal 40 of the recipient and the communication device 30. Alternatively, when the requester utters a voice to the voice input device 19, the information regarding the request to deliver the package can be input. In other words, the delivery request from the recipient and information of the recipient for authentication can be accepted by the operation panel 13, the reader 14, the communication device 30, or the voice input device 19. FIG. 6B schematically illustrates a state in which the recipient is using the mobile terminal 40 to transmit the delivery request to the home delivery device 1.

In S10, it is determined whether the delivery request has been provided from the recipient. When the delivery request has been provided, the process proceeds to S11. In S11, authentication to determine whether or not the requester is a valid recipient is performed. The authentication can be performed, for example, by inputting a reception code notified from the server 50 to the mobile terminal of the recipient in advance.

In S12, it is determined whether or not to permit the delivery of the package. When the authentication of the requester is successful in S11, the delivery of the package is permitted, and the process proceeds to S6. The processing of S6 and the processing of S7 subsequent to S6 are as described above. When the authentication of the requester is not successful in S11, the process proceeds to S13. In S13, a notification in which the requester that the authentication has failed is performed. The notification can be performed by outputting a voice by the voice output device 18 or displaying a message by the display units 5 to 7.

As described above, according to the present invention, it is possible to provide the home delivery device 1 capable of smoothly operating a home delivery service for a package.

<Summary of Embodiments>

The above-described embodiments disclose at least a home delivery device described as follows.

1. The home delivery device, of the embodiment, that autonomously delivers a package (201) to a dwelling (101) in an apartment building (100), comprises:

a detection unit (8-10) configured to detect a target around the home delivery device; and

a delivery determination unit (15, S5, S12) configured to determine whether or not to permit the delivery of the package, wherein

when the home delivery device arrives at the dwelling as a delivery destination and the detection unit detects that a person comes out of the dwelling, the delivery determination unit determines that the delivery of the package to the person is permitted (S4, S5).

According to the present embodiment, when it has been confirmed that a person has come from a dwelling, the authentication of the person is omitted since the person is regarded as a recipient or a person acting on behalf of the recipient and living in the same dwelling, and the delivery of the package is permitted. It is therefore possible to provide the home delivery device capable of smoothly operating a home delivery service for a package.

2. The home delivery device (1) of the embodiment, further comprises an acceptance unit (13, 14, 19, 30) configured to accept information of a request to deliver the package and information of a requester, wherein when the home delivery device does not arrive at the dwelling as the delivery destination and the acceptance unit accepts the delivery request and the information of the requester, the delivery determination unit determines that the delivery of the package is permitted on condition that the requester is authenticated as a valid recipient based on the information of the requester (S10-S12), and

when the home delivery device arrives at the dwelling as the delivery destination, and the detection unit detects that a person comes out of the dwelling, the delivery determination unit determines that the delivery of the package to the person is permitted without requiring authentication that the person is a valid recipient (S4,S5).

According to this embodiment, the package can be delivered to the recipient at a place different from the dwelling as the delivery destination, and the home delivery service can be smoothly operated. At that time, the package can be delivered to the recipient more reliably by using the authentication of the person as a condition.

3. The home delivery device (1) of the embodiment, further comprises an arrival determination unit (15, S1) configured to determine whether or not the home delivery device arrives at the dwelling as the delivery destination, wherein

the arrival determination unit determines that the home delivery device arrives at the dwelling as the delivery destination, at least on condition that the detection unit detects an identification display (101b) of the dwelling attached to the dwelling as the delivery destination.

According to this embodiment, it is possible to more accurately check the dwelling as the delivery destination.

4. The home delivery device (1) of the embodiment, further comprises a calling unit (7,18,30) configured to call a recipient when the home delivery device arrives at the dwelling as the delivery destination, wherein when the home delivery device arrives at the dwelling as the delivery destination, the calling unit calls the recipient, and the detection unit detects that a person comes out of the dwelling, the delivery determination unit determines that the delivery of the package to the person is permitted (S2-S5).

According to this embodiment, it is possible to cause the recipient of the dwelling as the delivery destination to more reliably recognize that the package to be delivered is present, and it is possible to more reliably deliver the package to the recipient by regarding the person who comes out in response to the delivery or a person acting on behalf of the recipient and living in the same dwelling as the recipient.

5. The home delivery (1) of the embodiment, further comprises:

a storage unit (3, 4)) configured to store a package; and

a switching unit (11) configured to switch the storage unit between an open state in which the package can be put in and taken out of the storage unit and a closed state in which it is difficult for the package to be put in and taken out of the storage unit, wherein

the switching unit switches the storage unit to the open state when the delivery determination unit permits delivery of the package (S6).

According to this embodiment, the package can be safely conveyed to the delivery destination.

6. The home delivery device (1) of the embodiment, further comprises a traveling unit (2) configured to travel along a common corridor (102) of the apartment building to move the home delivery device.

According to this embodiment, the package can be delivered by the home delivery device without providing special moving equipment on the apartment building side.

7. The home delivery device (1) of the embodiment, further comprises:

a display unit (5-7); and

a plurality of sets of the storage units and the switching units, wherein

the display unit performs a display for identifying the storage unit in which the package permitted to be delivered is stored (FIG. 6A).

According to this embodiment, it is possible to deliver a plurality of packages at the same time, and it is possible to cause the recipient to immediately recognize a storage unit in which a package is stored.

8. In the home delivery device of the embodiment, the detection unit includes an imaging unit configured to capture an image of a target around the home delivery device.

According to this embodiment, the operation of the home delivery device can be controlled based on an image captured by each of the imaging units, and a situation at the time of delivery can also be saved as a recorded image.

The invention is not limited to the foregoing embodiments, and various variations/changes are possible within the spirit of the invention.

What is claimed is:

1. A home delivery device that autonomously delivers a package to a dwelling in an apartment building, the home delivery device comprising:
a detection unit configured to detect a target around the home delivery device; and
a delivery determination unit configured to determine whether or not to permit the delivery of the package, wherein
when the home delivery device arrives at the dwelling as a delivery destination and the detection unit detects that a person comes out of the dwelling, the delivery determination unit determines that the delivery of the package to the person is permitted.

2. The home delivery device according to claim 1, further comprising
an acceptance unit configured to accept information of a request to deliver the package and information of a requester, wherein
when the home delivery device does not arrive at the dwelling as the delivery destination and the acceptance unit accepts the delivery request and the information of the requester, the delivery determination unit determines that the delivery of the package is permitted on condition that the requester is authenticated as a valid recipient based on the information of the requester, and
when the home delivery device arrives at the dwelling as the delivery destination, and the detection unit detects that a person comes out of the dwelling, the delivery determination unit determines that the delivery of the package to the person is permitted without requiring authentication that the person is a valid recipient.

3. The home delivery device according to claim 1, further comprising
an arrival determination unit configured to determine whether or not the home delivery device arrives at the dwelling as the delivery destination, wherein
the arrival determination unit determines that the home delivery device arrives at the dwelling as the delivery destination, at least on condition that the detection unit detects an identification display of the dwelling attached to the dwelling as the delivery destination.

4. The home delivery device according to claim 1, further comprising
a calling unit configured to call a recipient when the home delivery device arrives at the dwelling as the delivery destination, wherein
when the home delivery device arrives at the dwelling as the delivery destination, the calling unit calls the recipient, and the detection unit detects that a person comes out of the dwelling, the delivery determination unit determines that the delivery of the package to the person is permitted.

5. The home delivery device according to claim 1, further comprising:
a storage unit configured to store a package; and
a switching unit configured to switch the storage unit between an open state in which the package can be put in and taken out of the storage unit and a closed state in which it is difficult for the package to be put in and taken out of the storage unit, wherein
the switching unit switches the storage unit to the open state when the delivery determination unit permits delivery of the package.

6. The home delivery device according to claim 1, further comprising
a traveling unit configured to travel along a common corridor of the apartment building to move the home delivery device.

7. The home delivery device according to claim 5, further comprising:
a display unit; and
a plurality of sets of the storage units and the switching units, wherein
the display unit performs a display for identifying the storage unit in which the package permitted to be delivered is stored.

8. The home delivery device according to claim 1, wherein
the detection unit includes an imaging unit configured to capture an image of a target around the home delivery device.
